(19) United States
(12) Patent Application Publication
(10) Pub. No.: US 2018/0319102 A1
(43) Pub. Date: Nov. 8, 2018

(54) METHOD FOR MAKING A CURVED PART OUT OF A THERMOPLASTIC COMPOSITE WITH CONTINUOUS REINFORCEMENT

(71) Applicant: DAHER AEROSPACE, Saint Julien De Chedon (FR)

(72) Inventors: DIDIER KURTZ, PORNIC (FR); JULIE VAUDOUR, LA CHEVROLIERE (FR)

(21) Appl. No.: 16/031,870

(22) Filed: Jul. 10, 2018

Related U.S. Application Data
(63) Continuation-in-part of application No. 14/381,587, filed on Aug. 27, 2014, now Pat. No. 10,016,931.

(30) Foreign Application Priority Data
Feb. 29, 2012 (FR) 12 51877

(51) Int. Cl. B29C 70/38; B29C 70/46

(52) U.S. Cl. CPC B29C 70/382; B29K 2071/00; B29C 70/465; B29C 70/462

(57) ABSTRACT

A method for manufacturing a curved part made of a stack of plies of continuous fibers in a thermoplastic polymer matrix. The part having at least one in-plane curved ply in one of the flanges, where the fibers are aligned with the curvature. The fiber placement parameters are determined to obtain welding of the fibers on a pre-deposited ply without diffusion of segments of the polymer's molecular chains through the interface between the fibers and the pre-deposited ply. An in-plane curved flat blank is produced by automated fiber placement using the parameters. The blank comprises at least one ply where fibers are aligned with the curvature and having an overall porosity content lower than 1%. The blank heated to a temperature greater than the melting temperature of the polymer is hot stamped and consolidated to provide the curved composite part with continuous fiber reinforcement having at least two flanges.

### RELATED APPLICATIONS

This application is a continuation-in-part of U.S. application Ser. No. 14/381,587 filed Aug. 27, 2014, which is a § 371 application from PCT/FR2013/050431 filed Feb. 28, 2013, which claims priority from French Patent Application No. 12 51877 filed Feb. 29, 2012, each of which is herein incorporated by reference in its entirety

### TECHNICAL FIELD

The invention pertains to a method for manufacturing a composite thermoplastic part with continuous fiber reinforcement by a combination of fiber placement and stamping. The invention is particularly suited to the making of a composite structural part with at least two flanges extending in secant planes, particularly the making of a part in the form of an extrusion, in a CAD sense, comprising at least two flanges in a section, the centers of the successive sections of which follow a curve.

In a specific embodiment the thickness and the area of the sections may change over the length of the part.

Exemplary parts are of Z, U, L, J, V or hat shaped sections.

Aircraft fuselage frames, stringers, wing ribs or wing spars, door ribs or stiffeners, or components making the latter, are non-limiting examples of the type of parts the manufacture of which may take advantage of the method of the invention.

The aim of the invention is to provide a method for manufacturing such a part, comprising fibers that are parallel to its curvature, i.e. oriented at 0°, over the whole length of the part. Such fibers follow an in-plane curvature in a same ply and provide buckling resistance when such a part is subjected to a loading.

### BACKGROUND OF THE INVENTION

Continuous fiber reinforced thermoplastic composite members are as lightweight and resistant as their thermoset counterparts but exhibit a better smoke and fire resistance as well as higher impact resistance, making them desirable for demanding applications such as in aeronautics.

Such a part can be made by automated fiber placement, or AFP, as disclosed in document US2006/0249868A1. But implementing AFP with fibers pre-impregnated with a thermoplastic polymer is slow and complex, first of all because a thermoplastic polymer does not exhibit tackiness like a non-cure thermoset resin does. Therefore, upon deposition, deposited pre-impregnated fibers as well as previously deposited plies shall be heated to a temperature above the melting temperature of the thermoplastic polymer to provide adhesion and co-consolidation, so called autohesion, of the deposited ply on the preform, upon the subsequent cooling. This means that the molten polymer shall be contained on the deposition site, from melting to cooling, which is usually difficult in an open space such as an AFP machine, and furthermore complicated when the deposition head follows a 3D trajectory.

Even when considering the alternative embodiment taught in this document, consisting in laying up a flat preform by AFP, and then applying this preform over a 3D mandrel, if this method can be implemented with thermoset resin impregnated fibers, where the flat preform is flexible because it's still in an uncured state, such a flat preform will be stiff when made of a thermoplastic composite, making it impossible to wrap the mandrel with the preform.

A composite part with a continuous reinforcement in a thermoplastic matrix with the appropriate shape may also be obtained by stamping a fully consolidated reinforced thermoplastic blank, trimmed out of a fully consolidated plate. However, this method does not allow to get a curved member comprising fibers aligned with its curvature.

### OBJECT AND SUMMARY OF THE INVENTION

The invention aims to remedy the drawbacks of the prior art and to this end relates to a method for manufacturing a part made of a stack of plies of continuous fibers in a thermoplastic polymer matrix, said part having at least two flanges and being curved, and comprising at least one in-plane curved ply in one the flanges where the fibers are aligned with the curvature, the method comprising the steps of:

determining a heating temperature and a deposition velocity of the thermoplastic polymer impregnated fibers so as to obtain a welding of said fibers on a pre-deposited ply without diffusion of segments of molecular chains of the polymer through the interface between the deposited fibers and the pre-deposited ply;

obtaining an in-plane curved flat blank by automatic fiber placement using the temperature and velocity parameters thus defined, said blank comprising at least one ply where the fibers are aligned with the curvature, and having an overall porosity content lower than 1%;

heating the blank thus obtained to a temperature greater than or equal to the melting temperature of the polymer making up the matrix;

hot stamping and consolidating the heated flat blank between a stamping punch and a die to provide the curved composite part comprising at least two flanges with a continuous fiber reinforcement.

When applied to thermoplastic fibers, the terms ‘pre-impregnated’ or Impregnated' are used here to refer to thermoplastic strands calendared with a polymer film, powdered with a thermoplastic polymer or comprising thermoplastic fibers comingled with the reinforcing fibers. In all cases, the reinforcing fibers themselves are not impregnated or are only partly impregnated with the polymer. This type of product is a product that is effectively available in the market under the improper name of thermoplastic pre-impregnated/impregnated fibers.

The invention can be implemented advantageously in the embodiments described below, which may be considered individually or in any technically operative combination.

The step of determining the automated fiber placement parameters comprises the step of:
conducting automated fiber placement trials while measuring during the lay up the temperature at the interface between the deposited fibers and the pre-deposited ply.

The automated fiber placement parameters comprise an interface heating temperature ranging between Tm+5° C. and Tm+10° C. where Tm is the melting temperature of the thermoplastic polymer and the deposition velocity is comprised between 5 m.min⁻¹ and 60 m.min⁻¹

The thermoplastic polymer is a polyaryletherketone.

The making of the curved flat blank comprises the deposition of strips oriented at an angle α relative to the curvature.

In a specific embodiment, the step of making the flat blank by automated fiber placement comprises a ply drop-off in order to make a part with a variable thickness over its length.

### BRIEF DESCRIPTION OF THE DRAWINGS

The invention is hereby described in its preferred embodiments, which are not limitative in any way, and by reference to FIGS. 1 to 10, wherein:

FIG. 1 is a top view showing the blank during the automated fiber placement step of the method of the invention;

FIG. 2 is a top view of the flat blank after completion of the AFP operation;

FIG. 3 shows a cross section of the part just after the stamping operation, the section being according a A-A plane defined in FIG. 4;

FIG. 4 shows a perspective view of an example of a member obtained by the method according to the invention;

FIG. 5 is a schematic illustration according to a profile view of an exemplary implementation of an automated fiber placement operation;

FIG. 6 is an example of a DSC curve related to a thermoplastic polymer;

FIG. 7 shows the ideal temperature profile in a deposited strip to be achieved according to the invention;

FIG. 8 shows a schematic experimental setup for measuring the temperature at the interface between a deposited tow and a pre-deposited ply during an AFP operation;

FIG. 9 shows an exemplary experimental setup for calibrating the measurement performed by the setup shown in FIG. 7 with regard to the emissivity of the tow and of the pre-deposited ply; and

FIG. 10 shows in perspective view, examples of parts having an evolutive section and made by the method of the invention.

### DETAILED DESCRIPTION OF THE EMBODIMENTS

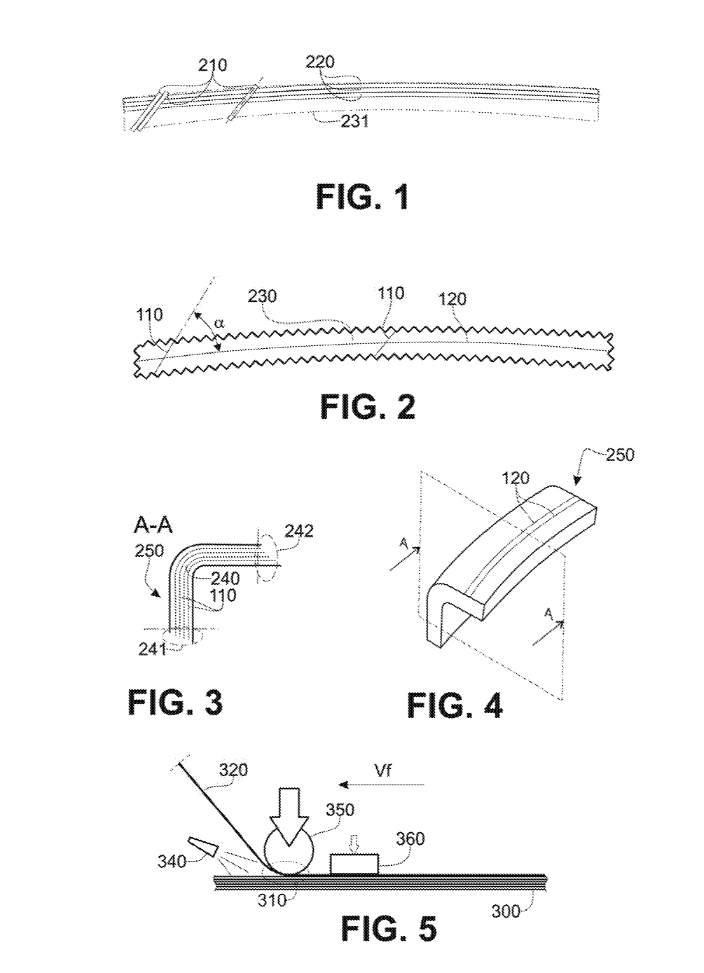

FIG. 1, according to an exemplary embodiment of the actual manufacturing steps pertaining to the method of the invention, said method comprises a first laying up step, consisting in depositing tows or strips (210, 220) of fibers oriented in relation with the actual contour (231) of the blank by placing fibers referred to as fibers pre-impregnated with a thermoplastic polymer. Such deposition operation is carried out by using a numerically controlled automated fiber placement machine.

The nature of reinforcing fibers hereby considered are carbon fibers, glass fibers or other fibers sharing the feature that they do not exhibit plasticity at the layup temperature.

Thus, strips or tows (220) oriented at 0° locally, follow that in-plane curved direction of the blank. To that end, said strips (220) are deposited along curved trajectories, through a method known as steering.

Tows (210) oriented along other directions, for example 45°, are also deposited by AFP so as to locally verify that direction.

AFP is a process where plies are made one at a time by laying up tows or strips comprising 2 to 16, most often 4 impregnated fibers. The fiber orientation may be different from one ply to the other.

FIG. 5 shows such an implementation of AFP when using fibers impregnated with a thermoplastic polymer.

A strip (320) of fibers is deposited on a preform (300) made up of a stack of fibrous plies that were made during a previous deposition. During the layup, the interface between the strip (320) being deposited and the preform (300) is heated so as to melt the thermoplastic polymer of the strip and of the underneath preform at the deposition site (310), using heating means (340) such as a laser beam or a hot gas blower. The strip (320) is immediately pressed on the preform, by pressing means (350), for example by means of a pressure roller. Under the effect of that pressure and temperature, the strip (320) is bond to the preform (300). The pressure roller (350) and the heating means (340) move at a velocity Vf as depositing is carried out, while tension means (not shown) provide the permanent tension of the undeposited part of the fibrous strip (320). Chilling means (360) moving with the pressure roller rapidly cool the deposited strip which is then part of the preform.

Heating is mandatory for at least two reasons. To begin with, unlike uncured thermosets the thermoplastic polymer does not exhibit tackiness. Therefore, the only way known to bond the deposited strip to the preform is to heat the interface between the preform and the strip to high enough a temperature, pressing the strip on the preform and subsequently cooling the whole. If the temperature is high enough and the deposition velocity slow enough during this process, percolation of the polymer between the plies will occur and molecular chains will develop upon condensation of the molten polymer, crossing the interface between the preform and the as deposited strip, making it a fully consolidated material. This is the result usually sought in thermoplastic AFP. In order for the consolidation to take place while using a reasonable industrial deposition velocity the polymer shall be heated to a temperature well above its melting temperature (Tm), usually up to 50° C. above the melting temperature.

Second, as thermoplastic impregnated strips are relatively rigid and brittle at ambient temperature, and because the reinforcing fibers do not exhibit plasticity, for the steering process to be performed when depositing fibers along a curved path, the polymer shall be in a state soft enough to enable inter-strands shearing inside the strip at the deposition site (310). This state is also achieved by heating.

However, when the polymer is heated to so high a temperature, it is in a fairly fluid state, which is difficult to contain in a nearly open environment such as shown in FIG. 5, and further phenomena occur such as bulking, i.e. the increase of the volume of the polymer, and gaseous emissions.

If the temperature is even higher, or the time spent at this temperature too long, cross linking and oxidation may also occur. Therefore, although full consolidation is achieved the resulting material will usually exhibit porosities, making it unfit for demanding applications. Typically, parts made by this method exhibit a porosity content of about 10%.

Although the part may be deconsolidated and reconsolidated in a further operation in order to reduce the porosity content, such an operation requires expensive tooling, subjects the polymer to another melting-condensation thermal cycle that may harm its properties, and cannot fully cure the deficiencies, particularly if the part is thick and/or if the porosity content is too high e.g. more than 2%. As a matter of fact, each porosity collects the gaseous emissions upon heating and will hardly vanish.

To this end, according to the method of the invention specific deposition parameters are determined for the AFP operation, allowing to get a pre-consolidated curved flat blank exhibiting a low porosity content.

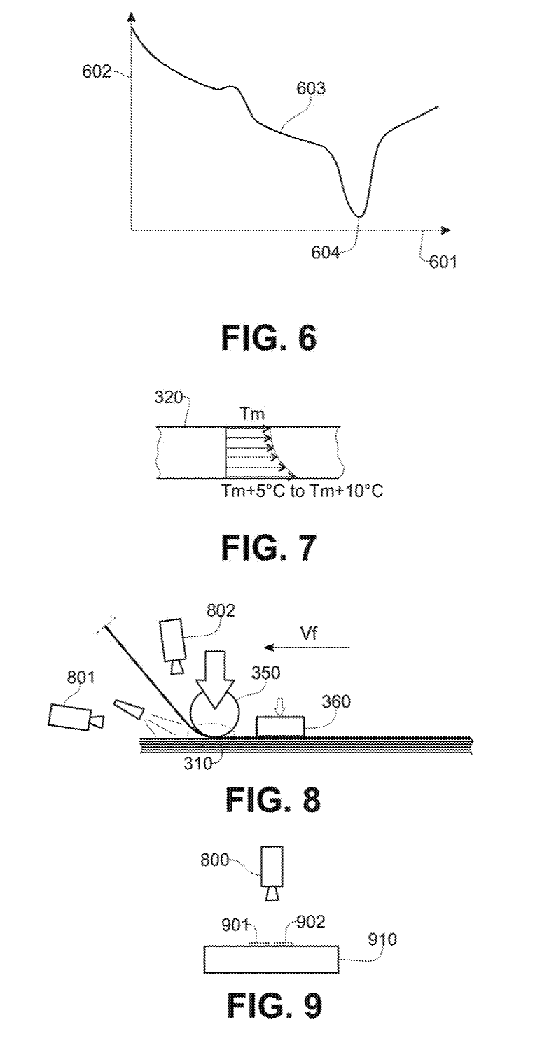

FIG. 6 shows an example of a Differential Scanning Calorimetry spectrum of a thermoplastic polymer. Such a curve (603) is obtained by subjecting a sample of a polymer and a reference sample to a thermal cycle and measuring the difference in the amount of heat (602) required to increase the temperature of the sample and the reference as a function of temperature (601). This method is well known from prior art and is not further detailed

The endothermic peak (604) defines the melting temperature of the polymer. As a for instance, this melting temperature is 343° C. for polyethertherketone (PEEK), 400° C. for polyetherketoneketone (PEKK), or 370° C. for polyetherketone (PEK).

Although this temperature is a melting temperature, when heated to this temperature the polymer is a highly viscous fluid. The viscosity of the polymers quoted above is about 5,000 poise or higher at their melting temperature which, as a comparable, is in the same order of magnitude than the viscosity of a window putty. As another comparable, the viscosity of an uncured epoxy resin at ambient temperature is several hundreds times lower, exhibiting a viscosity similar to that of a maple syrup.

The inventors have determined that although the viscosity at the melting temperature is high the polymer is soft enough to perform the steering operation, without damaging the fibers, provided that the whole strip is at least at the melting temperature at the deposition site.

The inventors also determined that if the interface between the deposited strip and the preform is heated to a temperature slightly over the melting temperature at the deposition site, the polymer is soft enough for the surfaces on both sides of the interface to match their respective roughness when pressed together, enabling an intimate contact between the deposited strip and the preform, and a strong bonding, called welding, of the strip on the preform, together with a very low porosity content, i.e. lower than 1%.

Yet, the bonding of the strip is not consolidated, meaning that the polymer interface between the strip and the preform is still visible on a micrograph, and the segments of the molecular chains of the polymer do not cross the interface between two plies.

As a consequence, the ideal temperature profile in the thickness of the deposited strip at the deposition site shall look like FIG. 7, where the whole thickness is at a temperature at least equal to the Tm temperature, and the temperature at the interface is in a range of 5° C. to 10° C. above the melting temperature. Increasing the temperature at the interface increases bulking and gaseous emissions of the polymer, leading to a higher porosity content.

In order to achieve this result, the parameters of the AFP process have to be set. The temperature at the interface depends on the heating power of the heating means and on the deposition velocity, as well as on heat transfer parameters connected to the deposited material. Among these variables, the deposition velocity Vf is the most flexible and reliable one to adjust.

To this end, FIG. 8, as an exemplary embodiment, an experimental setup is used to find the optimal deposition velocity range fulfilling the desired conditions.

This experimental setup preferably uses the same AFP machine as the production machine but implements an infrared thermography camera (801) focused on the interface between the deposited strip and the preform at the deposition site (310). To further improve the measurement a second thermographic camera (802) may be set, focused on the other side of the strip.

This set up provides accurate temperature measurement provided that the emissivity of the deposited material at the measurement temperature is known. Such a data can be obtained by bibliographic references, or experimentally using a setup such as shown in FIG. 9.

In this experiment, two samples (901, 902) of the deposited material are used. One of the sample is painted with a heat resistant black paint of known emissivity. The two samples are heated together in an oven up to the presumed temperature to be measured.

Once the temperature is reached, the two samples are quickly removed from the oven and placed on a thermally insulating support (910) under the camera (800) hold by a stand. By comparing the thermal image of the two samples the emissivity of the non-painted sample can be determined.

Returning to FIG. 8, trials are conducted by varying the deposition velocity Vf until the aimed result is achieved. Depending on the power of the heating means and on the deposited material, the adapted deposition velocity ranges between 5 m·min⁻¹ and 60 m·min⁻¹ and is usually between 20 m·min⁻¹ and 30 m·min⁻¹.

Such measurements may be supplemented by micrographs of samples taken from the experimental layup and showing the interface between the plies.

Thus, the method of the invention allows very high deposition velocities. Because the blank is laid up on flat, deposition trajectories follow in plane curves making such high velocities achievable with most of modern machines.

Once the conditions have been determined for a given material and a given machine, it is no longer necessary to conduct further trials.

These conditions allow depositing at a high speed Vf, while allowing a porosity rate in the preform less than 1%. The layup method by fiber placement makes it possible to deposit fibers along curved paths. This depositing method is known in the prior art and is referred to as ‘steering’.

This steering, which involves inter-strands shearing inside the deposited tow upon layup, is made possible because the thermoplastic polymer impregnating the fibers is heated at least up to its melting temperature at the deposition site.

FIG. 2, the blank (230) made by the AFP process of the invention is a flat solid and cohesive blank that can be easily manipulated.

Each ply is made of a plurality of strips/tows.

The reinforcements at 0° (120) follow the curvature of the blank (230) and the reinforcements (110) oriented along an angle retain their directions relative to the reinforcement at 0° throughout the length of the blank.

Although the blank is rigid, since the stack of ply is not consolidated, the plies being only welded to each other, its mechanical property are poor and the blank as such cannot be used as a structural part, even for undemanding applications. It's an intermediary product.

In order to get the final part, the blank (230) is raised to a temperature greater than the melting temperature of the thermoplastic polymer that makes up the matrix, for example, with infrared radiation, usually up to a temperature at least 50° C. higher than the melting temperature of the polymer. Then, the blank is stamped between a punch and a die according to a hot stamping method known in the prior art, to obtain the finished part (250).

FIG. 3, the stamping method uses phenomena of inter-laminar slipping and percolation of polymer between the plies and ends with a step of compacting-consolidation of the part into shape, between the punch and the die. All these operations are performed in a single stroke of the punch.

At the end of the stamping operation, the raw part comprises a majority portion (240) that is entirely compacted and consolidated, with a porosity rate less than 0.5%, and, at the ends of the flanges, uncompacted zones (241, 242) that show signs of inter-laminar slipping. These zones are eliminated by trimming with an abrasive water jet or by routing with a cutting tool.

FIG. 4, the part (250) is finished at the end of the routing process. The reinforcements (120) at 0° follow the curvature of the part, while the reinforcements (110) oriented along an angle in relation to that direction extend from one edge of the part to the other and extend in both secant planes of the flanges, as shown in the sectional view of FIG. 3. The fibrous reinforcements are already correctly oriented in the blank before stamping, therefore subjected to reduced stresses during the shaping and keeping their nominal direction with tight tolerance.

Besides bringing the part to its final shape with 2 or more flanges, the stamping process achieves full consolidation of the part, thus conferring to it its final and required mechanical properties.

Therefore, both the AFP and the stamping operations are required to make the final part. The AFP process as defined by the invention is useless if it is not followed by a stamping since the blank has very poor mechanical properties. The further consolidation and shaping of the blank can only be performed by stamping since the blank is rigid and flat and cannot be consolidated in shape as such.

Furthermore, the making of the blank according to the method of the invention improves the results achieved by the stamping process. As a matter of fact, the porosity content of the blank being very low, it enables a uniform heating process, both thickness and surface wise, thus favoring smooth interlaminar slipping of the plies during the stamping. Since the interfaces between the plies in the blank are relatively weak because they are only welded to each other, this also favors a smooth interlaminar slipping during the stamping process.

Therefore, the AFP and the stamping processes according to the method of the invention are in synergy.

Finally, because hot stamping is a highly productive process and because the AFP process according to the invention is carried out at a high velocity, the overall productivity of the method of the invention is very high, even higher than the one of the manufacturing of such a part using thermoset impregnated fibers laid up in shape by AFP and further cured.

The maximum thickness of the part depends on the in-plane curvature radius and on the fillet radius connecting the flanges. The higher the latter, the higher the achievable thickness.

As a non-limiting example, in aeronautics, typical members made by the method of the invention comprise more than 80 plies and even more than 100 plies, leading to thicknesses ranging from 10 to 20 mm.

The invention is more particularly adapted to the manufacturing of parts having a polyaryletherketone (PAEK) polymer matrix such as PEK, PEEK, PEKK that are resistant to impact, wear, fire and smoke, although other polymers such as polyphenylene sulfide (PPS) may also be considered without departing from the invention.

The method of the invention enables to make parts with a thickness variation along their length, meaning having different numbers of plies along their length.

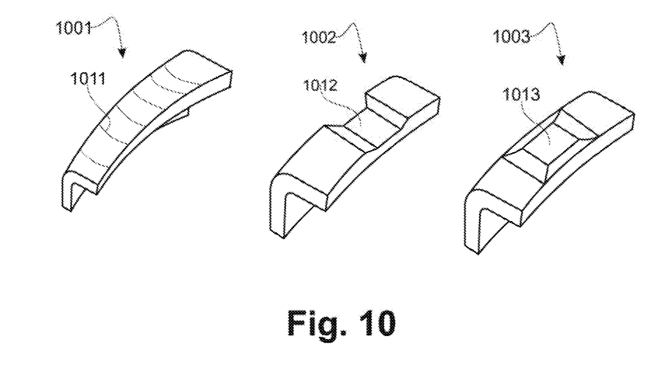

FIG. 10 shows examples of such parts.

The thickness variation is obtained at the layup step by plies drops-off (1011). This technique allows the making of a part (1001) with evolutive thickness and section, or a part (1002) featuring one or more pockets (1012) or a part (1003) featuring one or more local reinforcements (1013), or combination thereof.

The thickness evolution as well as the pocket or the local reinforcement may extend over one flange only or over part or all the flanges of a local cross section.

1. A method for manufacturing a part made of a stack of plies of continuous fibers in a thermoplastic polymer matrix, said part having at least two flanges and being curved, said part comprising at least one in-plane curved ply in one flange where the fibers are aligned with a curvature, the method comprising steps of:
determining automated fiber placement parameters to obtain a welding of the fibers on a pre-deposited ply without diffusion of segments of molecular chains of a polymer through an interface between the fibers and the pre-deposited ply, the automated fiber placement parameters comprise a heating temperature and a deposition velocity of a thermoplastic polymer impregnated fibers;
producing an in-plane curved flat blank by an automated fiber placement using the automated fiber placement parameters, said in-plane curved flat blank comprising at least one ply where fibers are aligned with the curvature and having an overall porosity content lower than 1%;
heating said in-plane curved flat blank to a temperature greater than a melting temperature of the thermoplastic polymer making up the thermoplastic polymer matrix; and
hot stamping and consolidating the heated in-plane curved flat blank between a stamping punch and a die to provide a curved composite part with continuous fiber reinforcement comprising at least two flanges.

2. The method of claim 1, wherein the step of determining the automated fiber placement parameters comprises a step of conducting automated fiber placement trials while measuring a temperature at the interface between the deposited fibers and the pre-deposited ply during a layup.

3. The method of claim 2, wherein the automated fiber placement parameters comprise an interface heating temperature ranging between Tm+5° C. and Tm+10° C., where Tm is the melting temperature of the thermoplastic polymer and the deposition velocity ranging between 5 m·min⁻¹ and 60 m·min⁻¹.

4. The method of claim 3, wherein the thermoplastic polymer is a polyaryletherketone.

5. The method of claim 1, wherein a layup of the in-plane curved flat blank comprises deposition of strips oriented at an angle α relative to the curvature.

6. The method of claim 1, wherein the step of producing an in-plane curved flat blank by the automated fiber placement comprises a ply drop-off to make a part with a variable thickness over a length of the part.
